(19) United States
(12) Patent Application Publication
(10) Pub. No.: US 2013/0035229 A1
(43) Pub. Date: Feb. 7, 2013

(54) FUNGICIDAL MIXTURES I COMPRISING QUINAZOLINES

(71) Applicants: Bernd Müller, Frankenthal (DE); Thorsten Jabs, Hassloch (DE); Jan Klaas Lohmann, Lambsheim (DE); Wassilios Grammenos, Ludwigshafen (DE); Marianna Vrettou-Schultes, Mannheim (DE); Egon Haden, Speyer (DE)

(72) Inventors: Bernd Müller, Frankenthal (DE); Thorsten Jabs, Hassloch (DE); Jan Klaas Lohmann, Lambsheim (DE); Wassilios Grammenos, Ludwigshafen (DE); Marianna Vrettou-Schultes, Mannheim (DE); Egon Haden, Speyer (DE)

(73) Assignee: BASF SE, Ludwigshafen (DE)

(21) Appl. No.: 13/640,361

(22) PCT Filed: Apr. 12, 2011
(86) PCT No.: PCT/IB2011/051575

§ 371 Date: Oct. 10, 2012

Related U.S. Application Data
(60) Provisional application No. 61/324,326, filed on Apr. 15, 2010.

(30) Foreign Application Priority Data
Apr. 15, 2010 (EP) 10160028.6

(51) Int. Cl. A01N 43/54; A01P 3/00; A01N 63/02; A01N 63/04; A01C 1/06; A01N 43/56

(52) U.S. Cl. 504/100; 514/266.21; 424/93.46; 424/93.462; 424/93.5

(57) ABSTRACT

The present invention relates to fungicidal mixtures, comprising at least one quinazo-line compound I and one compound II as defined in the description, and to compositions comprising these mixtures.

The present invention relates to mixtures comprising, as active components

1) at least one compound of formula I

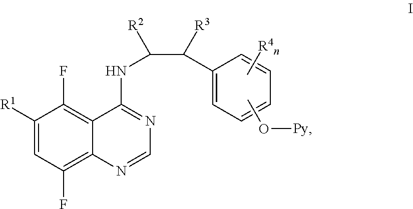

wherein:
R¹ is either H or F;
R² is either H or CH₃;
R³ is either H or CH₃;
R⁴ is CN, halogen, C₁-C₂-alkyl or C₁-C₂-alkoxy;
n indicates the number of substituents R4 on the phenyl ring and n is 0, 1 or 2,
Py is pyrimidyl or pyridyl, wherein the aforementioned heteroaromatic radicals are unsubstituted or carry 1, 2 or 3 identical or different substituents R^{a}; R^{a} is CN, halogen, C₁-C₂-alkyl, C₁-C₂-haloalkyl or C₁-C₂-alkoxy;
and the N-oxides and the agriculturally acceptable salts of the compounds of the formula I;
   and

2) at least one fungicidally active compound II selected from:
fluxapyroxad, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-di-methyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-[3-(2-chlorophenyl)-2-(3-fluorophenyl)-oxiranylmethyl]-2H-[1,2,4]triazole-3-thiol, 2-[2-(3-fluorophenyl)-3-(2-fluorophenyl)-oxiranylmethyl]-2H-[1,2,4]triazole-3-thiol, 2-[(3-fluorophenyl)-3-o-tolyl-oxiranylmethyl]-2H-[1,2,4]triazole-3-thiol, 1-[2-(3-fluorophenyl)-3-(2-fluorophenyl)-oxiranylmethyl]-5-methylsulfanyl-1H-[1,2,4]triazole, 1-[2-(3-fluorophenyl)-3-o-tolyl-oxiranylmethyl]-5-methylsulfanyl-1H-[1,2,4]triazole, 1-[3-(2-chlorophenyl)-2-(3-fluorophenyl)-oxiranylmethyl]-5-methylsulfanyl-1H-[1,2,4]triazole, 1-[3-(2-chlorophenyl)-2-(3-fluorophenyl)-oxiranylmethyl]-5-methanesulfonyl-1H-[1,2,4]triazole, thiocarbonic acid S-{2-[3-(2-chlorophenyl)-2-(3-fluorophenyl)-oxiranylmethyl]-2H-[1,2,4]triazol-3-yl}ester methyl ester, 1-[3-(2-chlorophenyl)-2-(3-fluorophenyl)-oxiranylmethyl]-5-thiocyanato-1H-[1,2,4]triazole, thioacetic acid S-{2-[3-(2-chlorophenyl)-2-(3-fluorophenyl)-oxiranylmethyl]-2H-[1,2,4]triazol-3-yl}ester, 2-[3-(2-chlorophenyl)-2-(2,4-difluorophenyl)-oxiranylmethyl]-2H-[1,2,4]triazole-3-thiol, 2-[2-(3,4-difluorophenyl)-3-o-tolyl-oxiranylmethyl]-2H-[1,2,4]triazole-3-thiol, 2-[3-(2-chlorophenyl)-2-(3,4-difluorophenyl)-oxiranylmethyl]-2H-[1,2,4]triazole-3-thiol, 2-[2-(3,4-difluorophenyl)-3-(2-trifluoromethylphenyl)-oxiranylmethyl]-2H-[1,2,4]triazole-3-thiol, 1-[3-(2-chlorophenyl)-2-(3,4-difluorophenyl)-oxiranylmethyl]-5-methylsulfanyl-1 H-[1,2,4]triazole, 1-[2-(2,4-difluorophenyl)-3-(2-fluorophenyl)-oxiranylmethyl]-5-methylsulfanyl-1H-[1,2,4]triazole, 1-[3-(2-chlorophenyl)-2-(2,4-difluorophenyl)-oxiranylmethyl]-5-methylsulfanyl-1H-[1,2,4]triazole, 1-[3-(2-chlorophenyl)-2-(2,4-difluorophenyl)-oxiranylmethyl]-5-thiocyanato-1H-[1,2,4]triazole, thiocarbonic acid S-{2-[3-(2-chlorophenyl)-2-(2,4-difluorophenyl)-oxiranylmethyl]-2H-[1,2,4]triazol-3-yl}ester methyl ester, 2-[2-(2-chlorophenyl)-3-(2,4-dichlorophenyl)-oxiranylmethyl]-2H-[1,2,4]triazole-3-thiol, 2-[3-(3-chloro-2-fluorophenyl)-2-(4-fluorophenyl)-oxiranylmethyl]-2H-[1,2,4]triazole-3-thiol, 2-[2-phenyl-3-(2,3,4-trichlorophenyl)-oxiranylmethyl]-2H-[1,2,4]triazole-3-thiol, 1-[2-(2-chlorophenyl)-3-(2,4-dichlorophenyl)-oxiranylmethyl]-5-methylsulfanyl-1H-[1,2,4]triazole, 1-[3-(3-chloro-2-fluorophenyl)-2-(4-fluorophenyl)-oxiranylmethyl]-5-methylsulfanyl-1H-[1,2,4]triazole, 1-[2-phenyl-3-(2,3,4-trichlorophenyl)-oxiranylmethyl]-5-methylsulfanyl-1H-[1,2,4]triazole, 1-[2-(2-chlorophenyl)-3-(2,4-dichlorophenyl)-oxiranylmethyl]-5-methanesulfonyl-1H-[1,2,4]triazole, thiocarbonic acid S-{2-[2-(2-chlorophenyl)-3-(2,4-dichlorophenyl)-oxiranylmethyl]-2H-[1,2,4]triazol-3-yl}ester methyl ester, 1-[2-(2-chlorophenyl)-3-(2,4-dichlorophenyl)-oxiranylmethyl]-5-thiocyanato-1H-[1,2,4]triazole, 2-[3-(2-chlorophenyl)-2-(2-fluorophenyl)-oxiranylmethyl]-2H-[1,2,4]triazole-3-thiol, 1-[3-(2-chlorophenyl)-2-(2-fluorophenyl)-oxiranylmethyl]-5-methylsulfanyl-1H-[1,2,4]triazole, 1-[3-(2-chlorophenyl)-2-(2-fluorophenyl)-oxiranylmethyl]-5-thiocyanato-1H-[1,2,4]triazolo, thiocarbonic acid S-{2-[3-(2-chlorophenyl)-2-(2-fluorophenyl)-oxiranylmethyl]-2H-[1,2,4]triazol-3-yl}ester methyl ester, 2-[3-(2-chlorophenyl)-2-(4-fluorophenyl)-oxiranylmethyl]-2H-[1,2,4]triazole-3-thiol, 5-allylsulfanyl-1-[3-(2-chlorophenyl)-2-(2,4-difluorophenyl)oxiran-2-ylynethyl]-1,2,4-triazole, 2-[1-[3-(2,4-dichlorophenyl)-2-methylpropyl]-2-hydroxy-3,3-dimethylbutyl]-4H-1,2,4-triazole-3-thione, 3-chloro-5-(6-chloro-3-pyridyl)-6-methyl-4-(2,4,6-trifluorophenyl)pyridazine, N-[2-(2,4-dichlorophenyl)-2-methoxy-1 -methyl-ethyl]-3-(difluoromethyl)-1 -methyl-pyrazole-4-carboxamide, compounds of formula IIa

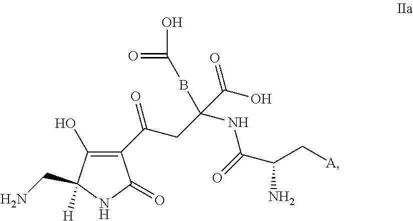

wherein:
B is either a direct bond or an alkylene group;
A is either OH or H;
and antifungal biocontrol agents and plant bioactivators selected from Ampelomyces quisqualis (e.g. AQ 10® from Intrachem Bio GmbH & Co. KG, Germany), Aspergillus flavus (e.g. AFLAGUARD® from Syngenta, CH), Aureobasidium pullulans (e.g. BOTECTOR® from bio-ferm GmbH, Germany), Bacillus pumilus (e.g. NRRL Accession No. B-30087 in SONATA® and BALLAD® Plus from AgraQuest Inc., USA), Bacillus subtilis (e.g. isolate NRRL-Nr. B-21661 in RHAPSODY®, SERENADE® MAX and SERENADE® ASO from AgraQuest Inc., USA), Bacillus subtilis var. amyloliquefaciens FZB24 (e.g. TAEGRO® from Novozyme Biologicals, Inc., USA), Candida saitoana (e.g. BIOCURE® (in mixture with lysozyme) and BIOCOAT® from Micro Flo Company, USA (BASF SE) and Arysta), Chitosan (e.g. ARMOUR-ZEN from BotriZen Ltd., NZ), Coniothyrium minitans (e.g. CONTANS® from Prophyta, Germany), Cryphonectria parasitica (e.g. Endothia parasitica from CNICM, France), Cryptococcus albidus (e.g. YIELD PLUS® from Anchor Bio-Technologies, South Africa), Metschnikowia fructicola (e.g. SHEMER® from Agrogreen, Israel), Microdochium dimerum (e.g. ANTI BOT® from Agrauxine, France), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis (e.g. REGALIA® from Marrone Biolnnovations, USA), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. harzianum T-22 (e.g. PLANTSHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000® from Mycontrol Ltd., Israel and Makhteshim Ltd., Israel), T. harzianum and T. viride (e.g. TRICHOPEL from Agrimm Technologies Ltd, NZ), T. harzianum ICC012 and T. viride ICC080 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (e.g. SOILGARD® from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy), and Ulocladium oudemansii HRU3 (e.g. BOTRY-ZEN® from Botry-Zen Ltd, NZ);
   in a synergistically effective amount.

The invention also relates to a method for controlling phytopathogenic harmful fungi using mixtures of at least one compound I and and at least one compound II and to the use of compounds I and compounds II for preparing such mixtures, and to compositions comprising these mixtures and seed comprising these mixtures or coated with this this mixture.

Practical agricultural experience has shown that the repeated and exclusive application of an individual active compound in the control of harmful fungi leads in many cases to a rapid selection of those fungus strains which have developed natural or adapted resistance against the active compound in question. Effective control of these fungi with the active compound in question is then no longer possible.

To reduce the risk of the selection of resistant fungus strains, mixtures of different active compounds are nowadays conventionally employed for controlling harmful fungi. By combining active compounds having different mechanisms of action, it is possible to ensure successful control over a relatively long period of time.

It is an object of the present invention to provide, with a view to effective resistance management and effective control of phytopathogenic harmful fungi, at application rates which are as low as possible, compositions which, at a reduced total amount of active compounds applied, have improved activity against the harmful fungi (synergistic mixtures) and a broadened activty spectrum, in particular for certain indications.

We have accordingly found that this object is achieved by the compositions, defined herein, comprising at least one compound I and at least one compound II.

Moreover, we have found that simultaneous, that is joint or separate, application of a compound I and a compound II or successive application of a compound I and of compound II allows better control of harmful fungi than is possible with the individual compounds alone (synergistic mixtures). Compounds I and/or the compounds II can be present in different crystal modifications, which may differ in biological activity.

Agriculturally acceptable salts of the compounds I encompass especially the salts of those cations or the acid addition salts of those acids whose cations and anions, respectively, have no adverse effect on the fungicidal action of the compounds I. Suitable cations are thus in particular the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry 1 to 4 C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium. Anions of useful acid addition salts are primarily chloride, bromide, fluoride, hydrogensulfate, sulfate, dihydrogenphosphate, hydrogenphosphate, phosphate, nitrate, bicarbonate, carbonate, hexafluorosilicate, hexafluorophosphate, benzoate, and the anions of C₁-C₄-alkanoic acids, preferably formate, acetate, propionate and butyrate. They can be formed by reacting a compound I with an acid of the corresponding anion, preferably of hydrochloric acid, hydrobromic acid, sulfuric acid, phosphoric acid or nitric acid.

The scope of the present invention includes mixtures of the (R)- and (S)-isomers and the racemates of compounds I and/or II having one or more chiral centers. As a result of hindered rotation of asymmetrically substituted groups, atrope isomers of compounds I and/or II may be present. They also form part of the subject matter of the invention.

Quinazoline compounds I and their preparation and their use as agrochemicals have been described in WO 2010/025451.

The compounds II described by common names and the antifungal biocontrol agents and plant bioactivators, their preparation and their activity against harmful fungi is known (cf.: http://www.alanwood.net/pesticides/); these substances and biocontrol agets are commercially available.

The compounds II described by IU PAC nomenclature, their preparation and their fungicidal activity are known from WO 2000/046184, WO 2005/120234, WO 2009/101078, WO 2009/101079, WO 2009/077471, WO 2009/077443, WO 2009/077500, WO 1996/038440 WO 2010/146006 and WO 1997/042178.

The use of compounds of formula IIa in fungicide applications is known from WO 2006/078939. Further, malonomicin or {[(2S)-2-amino-3-hydroxypropanoyl]amino}{2-[(5S)-5-(aminomethyl)-4-hydroxy-2-oxo-2,5-dihydro-IH-pyrrol-3-yl]-2-oxoethyl}malonic acid is a natural compound prepared by fennentation methods and is known for anti-protozoal activity. U.S. Pat. No. 3,536,811 discloses malonomicin used as antibiotics and inhibitors of protozoan growth.

The term “alkylene” refers to a branched or unbranched C₁-C₆-alkyl bridging group such as —CH₂—, CH₂CH₂—, and the like.

In one embodiment, the present invention relates to mixtures comprising as component 1) at least one compound I selected from
(5,8-Difluoro-quinazolin-4-yl)-{2-[4-(2-trifluoromethyl-pyridin-3-yloxy)-phenyl]-ethyl}-amine (I-1),
(5,8-Difluoro-quinazolin-4-yl)-{2-[4-(4-trifluoromethyl-pyridin-3-yloxy)-phenyl]-propyl}-amine (I-2),
(5,8-Difluoro-quinazolin-4-yl)-{2-[4-(6-trifluoromethyl-pyrimidin-4-yloxy)-phenyl]-ethyl}-amine (I-3),
(5,8-Difluoro-quinazolin-4-yl)-{2-[4-(6-trifluoromethyl-pyrimidin-4-yloxy)-phenyl]-propyl}-amine (I-4),
(5,8-Difluoro-quinazolin-4-yl)-{2-[4-(4-trifluoromethyl-pyridin-2-yloxy)-phenyl]-ethyl}-amine (I-5),
(5,8-Difluoro-quinazolin-4-yl)-{2-[4-(4-trifluoromethyl-pyridin-2-yloxy)-phenyl]-propyl}-amine (I-6),
(5,8-Difluoro-quinazolin-4-yl)-{2-[4-(5-trifluoromethyl-pyridin-2-yloxy)-phenyl]-ethyl}-amine (I-7),
(5,8-Difluoro-quinazolin-4-yl)-{2-[4-(5-trifluoromethyl-pyridin-2-yloxy)-phenyl]-propyl}-amine (I-8),
(5,8-Difluoro-quinazolin-4-yl)-{2-[4-(3-fluoro-5-trifluoromethyl-pyridin-2-yloxy)-phenyl]-ethyl}-amine (I-9),
(5,8-Difluoro-quinazolin-4-yl)-{2-[4-(3-fluoro-5-trifluoromethyl-pyridin-2-yloxy)-phenyl]-propyl}-amine (I-10),
(5,8-Difluoro-quinazolin-4-yl)-{2-[3-methoxy-4-(4-trifluoromethyl-pyridin-2-yloxy)-phenyl]-ethyl}-amine (I-11),
(5,8-Difluoro-quinazolin-4-yl)-{2-[2-fluoro-4-(4-trifluoromethyl-pyridin-2-yloxy)-phenyl]-ethyl}-amine (I-12),
2-Chloro-5-{4-[2-(5,8-difluoro-quinazolin-4-ylamino)-ethyl]-phenoxy}-isonicotinonitrile (I-13),
(5,6,8-trifluoro-quinazolin-4-yl)-{2-[4-(4-trifluoromethyl-pyridin-2-yloxy)-phenyl]-ethyl}-amine (I-14),
(5,6,8-trifluoro-quinazolin-4-yl)-{2-[4-(4-trifluoromethyl-pyridin-3-yloxy)-phenyl]-ethyl}-amine (I-15),
(5,6,8-trifluoro-quinazolin-4-yl)-{2-[3-chloro-4-(4-trifluoromethyl-pyridin-3-yloxy)-phenyl]-ethyl}-amine (I-16),
(5,8-Difluoro-quinazolin-4-yl)-{2-[4-(3-chloro-5-trifluoromethyl-pyridin-2-yloxy)-3-methoxy-phenyl]-ethyl}-amine (I-17),
(5,8-Difluoro-quinazolin-4-yl)-{2-[4-(4-trifluoromethyl-pyridin-2-yloxy)-3-methoxy-phenyl]-ethyl}-amine (I-18),and
(5,6,8-Trifluoro-quinazolin-4-yl)-{2-[4-(4-trifluoromethyl-pyridin-2-yloxy)-3-methoxy-phenyl]-ethyl}-amine (I-19).

According to one embodiment, in the inventive mixtures the rel-(2S;3R)-diastereomers of azolylmethyloxirane compounds II are used and selected from the following list of compounds II-1 to II-35:
2-[rel-(2S;3R)-3-(2-chlorophenyl)-2-(3-fluorophenyl)-oxiranylmethyl]-2H-[1,2,4]triazole-3-thiol (II-1),
2-[rel-(2S;3R)-2-(3-fluorophenyl)-3-(2-fluorophenyl)-oxiranylmethyl]-2H-[1,2,4]triazole-3-thiol (II-2),
2-[rel-(2S;3R)-(3-fluorophenyl)-3-o-tolyl-oxiranylmethyl]-2H-[1,2,4]triazole-3-thiol (II-3),
1-[rel-(2S;3R)-2-(3-fluorophenyl)-3-(2-fluorophenyl)-oxiranylmethyl]-5-methylsulfanyl-1H-[1,2,4]triazole (II-4),
1-[rel-(2S;3 R)-2-(3-fluorophenyl)-3-o-tolyl-oxiranylmethyl]-5-methylsulfanyl-1H-[1,2,4]triazole (II-5),
1-rel-(2S;3R)-3-(2-chlorophenyl)-2-(3-fluorophenyl)-oxiranylmethyl]-5-methylsulfanyl-1H-[1,2,4]triazole (II-6),
1-[rel-(2S;3R)-3-(2-chlorophenyl)-2-(3-fluorophenyl)-oxiranylmethyl]-5-methanesulfonyl-1H-[1,2,4]triazole (II-7),
thiocarbonic acid S-{2-[3-(2-chlorophenyl)-2-(3-fluorophenyl)-oxiranylmethyl]-2H-[1,2,4]triazol-3-yl}ester methyl ester (II-8),
1-[rel-(2S;3R)-3-(2-chlorophenyl)-2-(3-fluorophenyl)-oxiranylmethyl]-5-thiocyanato-1H-[1,2,4]triazole (II-9),
thioacetic acid S-{2-rel-](2S;3R)-3-(2-chlorophenyl)-2-(3-fluorophenyl)-oxiranylmethyl]-2H-[1,2,4]triazol-3-yl}ester (II-10),
2-[rel-(2S;3R)-3-(2-chlorophenyl)-2-(2,4-difluorophenyl)-oxiranylmethyl]-2H-[1,2,4]triazole-3-thiol (II-11),
2-[rel-(2S;3R)-2-(3,4-difluorophenyl)-3-o-tolyl-oxiranylmethyl]-2H-[1,2,4]triazole-3-thiol (II-12),
2-[rel-(2S;3R)-3-(2-chlorophenyl)-2-(3,4-difluorophenyl)-oxiranylmethyl]-2H-[1,2,4]triazole-3-thiol (II-13),
2-[rel-(2S;3R)-2-(3,4-difluorophenyl)-3-(2-trifluoromethylphenyl)-oxiranylmethyl]-2H-[1,2,4]triazole-3-thiol (II-14),
1-[rel-(2S;3R)-3-(2-chlorophenyl)-2-(3,4-difluorophenyl)-oxiranylmethyl]-5-methylsulfanyl-1H-[1,2,4]triazole (II-15),
1-[rel-(2S;3R)-2-(2,4-difluorophenyl)-3-(2-fluorophenyl)-oxiranylmethyl]-5-methylsulfanyl-1H-[1,2,4]triazole (II-16),
1-[rel-(2S;3R)-3-(2-chlorophenyl)-2-(2,4-difluorophenyl)-oxiranylmethyl]-5-methylsulfanyl-1H-[1,2,4]triazole (II-17),
1-[rel-(2S;3R)-3-(2-chlorophenyl)-2-(2,4-difluorophenyl)-oxiranylmethyl]-5-thiocyanato-1H-[1,2,4]triazole (II-18),
thiocarbonic acid S-{2-rel-[(2S;3R)-3-(2-chlorophenyl)-2-(2,4-difluorophenyl)-oxiranylmethyl]-2H-[1,2,4]triazol-3-yl}ester methyl ester (II-19),
2-[rel-(2S;3R)-2-(2-chlorophenyl)-3-(2,4-dichlorophenyl)-oxiranylmethyl]-2H-[1,2,4]triazole-3-thiol (II-20),
2-[rel-(2S;3 R)-3-(3-chloro-2-fluorophenyl)-2-(4-fluorophenyl)-oxiranylmethyl]-2H-[1,2,4]triazole-3-thiol (II-21),
2-[rel-(2S;3R)-2-phenyl-3-(2,3,4-trichlorophenyl)-oxiranylmethyl]-2H-[1,2,4]triazole-3-thiol (II-22),
1-[rel-(2S;3R)-2-(2-chlorophenyl)-3-(2,4-dichlorophenyl)-oxiranylmethyl]-5-methylsulfanyl-1H-[1,2,4]triazole (II-23),
1-[rel-(2S;3R)-3-(3-chloro-2-fluorophenyl)-2-(4-fluorophenyl)-oxiranylmethyl]-5-methyl-sulfanyl-1H-[1,2,4]triazole (II-24),
1-[rel-(2S;3R)-2-phenyl-3-(2,3,4-trichlorophenyl)-oxiranylmethyl]-5-methylsulfanyl-1H-[1,2,4]triazole (II-25),
1-[rel-(2S;3R)-2-(2-chlorophenyl)-3-(2,4-dichlorophenyl)-oxiranylmethyl]-5-methanesulfonyl-1H-[1,2,4]triazole (II-26),
thiocarbonic acid S-{2-rel-[(2S;3R)-2-(2-chlorophenyl)-3-(2,4-dichlorophenyl)-oxiranylmethyl]-2H-[1,2,4]triazol-3-yl}ester methyl ester (II-27),
1-[rel-(2S;3R)-2-(2-chlorophenyl)-3-(2,4-dichlorophenyl)-oxiranylmethyl]-5-thiocyanato-1H-[1,2,4]triazole (II-28),
2-[rel-(2S;3R)-3-(2-chlorophenyl)-2-(2-fluorophenyl)-oxiranylmethyl]-2H-[1,2,4]triazole-3-thiol (II-29),
1-[rel-(2S;3R)-3-(2-chlorophenyl)-2-(2-fluorophenyl)-oxiranylmethyl]-5-methylsulfanyl-1H-[1,2,4]triazole (II-30),
1-[rel-(2S;3R)-3-(2-chlorophenyl)-2-(2-fluorophenyl)-oxiranylmethyl]-5-thiocyanato-1H-[1,2,4]triazole (II-31),
thiocarbonic acid S-{2-rel-[(2S;3R)-3-(2-chlorophenyl)-2-(2-fluorophenyl)-oxiranylmethyl]-2H-[1,2,4]triazol-3-yl}ester methyl ester (II-32),
2-[rel-(2S;3R)-3-(2-chlorophenyl)-2-(4-fluorophenyl)-oxiranylmethyl]-2H-[1,2,4]triazole-3-thiol (II-33),
5-allylsulfanyl-1-[rel-(2S;3R)-[3-(2-chlorophenyl)-2-(2,4-difluorophenyl)oxiran-2-yl]-methyl]-1,2,4-triazole (II-34) and
rel-(1R;2R)-2-[1-[3-(2,4-dichlorophenyl)-2-methylpropyl]-2-(RS)-hydroxy-3,3-dimethylbutyl]-4H-1,2,4-triazole-3-thione (II-35).

According to another embodiment, in the inventive mixtures the compound II is Fluxapyroxad (II-36).

In a further embodiment, the present invention relates to mixtures comprising as component 2) the compound II-37 represented by the formula:

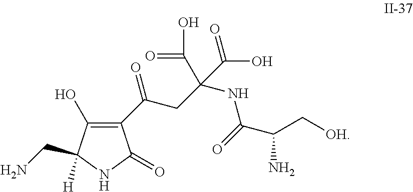 [SMILES: NC[C@@H]1NC(=O)C(C(=O)CC(NC(=O)[C@@H](N)CO)(C(=O)O)C(=O)O)=C1O]

In a further embodiment, the present invention relates to mixtures comprising the compound II-38 represented by the formula:

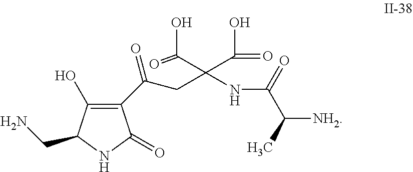 [SMILES: C[C@H](N)C(=O)NC(CC(=O)C1=C(O)[C@H](CN)NC1=O)(C(=O)O)C(=O)O]

In a further embodiment, the present invention relates to mixtures comprising the compound II-39 represented by the formula:

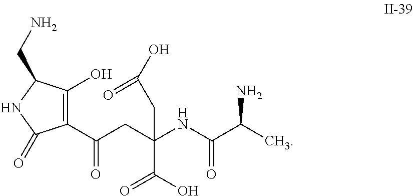 [SMILES: C[C@H](N)C(=O)NC(CC(=O)O)(CC(=O)C1=C(O)[C@H](CN)NC1=O)C(=O)O]

In another embodiment, the present invention relates to mixtures comprising the compound II-40 represented by the formula:

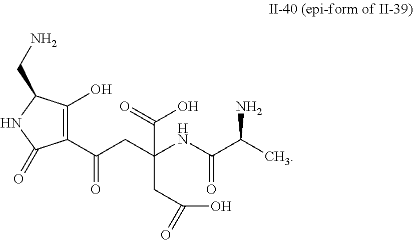 [SMILES: C[C@H](N)C(=O)NC(CC(=O)O)(CC(=O)C1=C(O)[C@H](CN)NC1=O)C(=O)O]

In another embodiment, the present invention relates to mixtures comprising the compound II-41 represented by the formula:

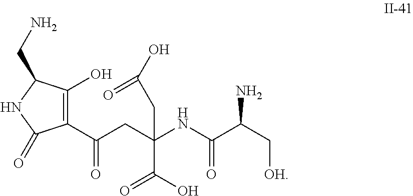 [SMILES: NC[C@@H]1NC(=O)C(C(=O)CC(CC(=O)O)(NC(=O)[C@@H](N)CO)C(=O)O)=C1O]

In another embodiment, the present invention relates to mixtures comprising the compound II-42 represented by the formula:

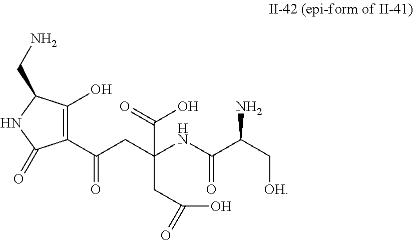 [SMILES: NC[C@@H]1NC(=O)C(C(=O)CC(CC(=O)O)(NC(=O)[C@@H](N)CO)C(=O)O)=C1O]

According to another embodiment, in the inventive mixtures the compounds II are from the following list of antifungal biocontrol agents and plant bioactivators II-43 to II-46:
Bacillus pumilus (II-43) (e.g. NRRL Accession No. B-30087 in SONATA® and BALLAD® Plus from AgraQuest Inc., USA), Bacillus subtilis (II-44) (e.g. isolate NRRL-Nr. B-21661 in RHAPSODY®, SERENADE® MAX and SERENADE® ASO from AgraQuest Inc., USA), Bacillus subtilis var. amyloliquefaciens FZB24 (II-45) (e.g. TAEGRO® from Novozyme Biologicals, Inc., USA), and Ulocladium oudemansii HRU3 (II-46) (e.g. BOTRY-ZEN® from Botry-Zen Ltd, NZ).

Particularly preferred are the binary mixtures wherein compounds I are selected from compounds I-1 to I-19 and compounds II are selected from compounds II-1 to II-46 as defined above and listed:

The mixtures and compositions thereof according to the invention can, in the use form as fungicides, also be present together with other active substances, e. g. with herbicides, insecticides, growth regulators, fungicides or else with fertilizers, as pre-mix or, if appropriate, not until immediately prior to use (tank mix).

Mixing the compounds I and compounds II and the compositions comprising them, respectively, in the use form as fungicides with other fungicides results in many cases in an expansion of the fungicidal spectrum of activity being obtained or in a prevention of fungicide resistance development. Furthermore, in many cases, synergistic effects are obtained.

According to the present invention, it may be preferred that the mixtures comprise besides one compound I and one compound II as component 3) a further active compound, preferably in a synergistically effective amount. Another embodiment relates to mixtures wherein the component 3) is an active compound III selected from groups A) to I): A) strobilurins, B) carboxamides, C) azoles, D) heterocyclic compounds, E) carbamatesl) insecticides.

The compounds III, their preparation and their biological activity e.g. against harmful fungi, pests or weed is known (cf.: http//www.alanwood.net/pesticides/).

It is preferred that the mixtures comprise as compounds III fungicidal compounds that are independently of each other selected from the groups A), B), C), D), E) and F).

According to another embodiment of the invention, mixtures comprise as compound III a herbicidal compound that is selected from the group H).

According to a further embodiment, mixtures comprise as compound III an insecticidal compound that is selected from the group I).

Preference is also given to mixtures comprising at least one compound III selected from the strobilurines of group A) and particularly selected from azoxystrobin, dimoxystrobin, enestroburin, fluoxastrobin, kresoxim-methyl, orysastrobin, picoxystrobin, pyraclostrobin, pyribencarb and trifloxystrobin.

Preference is also given to mixtures comprising at least one compound III selected from the carboxamides of group B) and particularly selected from bixafen, boscalid, fluopyram, fluxapyroxad, isopyrazam, penflufen, penthiopyrad, sedaxane, fenhexamid, metalaxyl, mefenoxam, ofurace, dimethomorph, flumorph, fluopicolid (picobenzamid), fluopram, penthiopyrad, zoxamide, carpropamid and mandipropamid.

Preference is given to mixtures comprising at least one compound III selected from the azoles of group C) and particularly selected from cyproconazole, difenoconazole, epoxiconazole, fluquinconazole, flusilazole, flutriafol, metconazole, myclobutanil, penconazole, propiconazole, prothioconazole, triadimefon, triadimenol, tebuconazole, tetraconazole, triticonazole, prochloraz, cyazofamid, benomyl and ethaboxam.

Preference is also given to mixtures comprising at least one compound III selected from the heterocyclic compounds of group D) and particularly selected from ametoctradin, fluazinam, cyprodinil, fenarimol, mepanipyrim, pyrimethanil, triforine, fludioxonil, dodemorph, fenpropimorph, tridemorph, fenpropidin, iprodione, vinclozolin, famoxadone, fenamidone, probenazole, proquinazid, acibenzolar-S-methyl, captafol, folpet, fenoxanil and quinoxyfen.

Preference is also given to mixtures comprising at least one compound III selected from the carbamates of group E) and particularly selected from mancozeb, metiram, propineb, thiram, iprovalicarb, benthiavalicarb and propamocarb.

Preference is also given to mixtures comprising at least one compound III selected from the fungicides given in group F) and particularly selected from dithianon, fentin salts, such as fentin acetate, fosetyl, fosetyl-aluminium, H₃PO₃ and salts thereof, chlorothalonil, dichlofluanid, thiophanat-methyl, copper acetate, copper hydroxide, copper oxychloride, copper sulfate, sulfur, cymoxanil, metrafenone, spiroxamine and N-methyl-2-{1-[(5-methyl-3-trifluoromethyl-1H-pyrazol-1-yl)-acetyl]-piperidin-4-yl}-N-[(1R)-1,2,3,4-tetrahydronaphthalen-1-yl]-4-thiazolecarboxamide.

Particular preference is also given to mixtures comprising as compound III one compound selected from the strobilurines of group A) and particularly selected from azoxystrobin, dimoxystrobin, enestroburin, fluoxastrobin, kresoxim-methyl, orysastrobin, picoxystrobin, pyraclostrobin, pyribencarb and trifloxystrobin, and as compound III at least one compound selected from the carboxamides of group B) and particularly selected from bixafen, boscalid, fluopyram, isopyrazam, penflufen, penthiopyrad, sedaxane, fenhexamid, metalaxyl, mefenoxam, ofurace, dimethomorph, flumorph, fluopicolid (picobenzamid), penthiopyrad, zoxamide, carpropamid, mandipropamid and fluxapyroxad.

The mixtures and compositions according to the invention are suitable as fungicides. They are distinguished by an outstanding effectiveness against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). Some are systemically effective and they can be used in crop protection as foliar fungicides, fungicides for seed dressing and soil fungicides. Moreover, they are suitable for controlling harmful fungi, which inter alia occur in wood or roots of plants.

The mixtures and compositions according to the invention are particularly important in the control of a multitude of phytopathogenic fungi on various cultivated plants, such as cereals, e. g. wheat, rye, barley, triticale, oats or rice; beet, e. g. sugar beet or fodder beet; fruits, such as pomes, stone fruits or soft fruits, e. g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e. g. conifers; and on the plant propagation material, such as seeds, and the crop material of these plants.

Preferably the inventive mixtures and compositions are used for controlling a multitude of fungi on field crops, such as potatoes sugar beets, tobacco, wheat, rye, barley, oats, rice, corn, cotton, soybeans, rape, legumes, sunflowers, coffee or sugar cane; fruits; vines; ornamentals; or vegetables, such as cucumbers, tomatoes, beans or squashes.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring.

Preferably, treatment of plant propagation materials with the inventive combination of compound I and compounds II and compositions thereof, respectively, is used for controlling a multitude of fungi on cereals, such as wheat, rye, barley and oats; rice, corn, cotton and soybeans.

The term “cultivated plants” is to be understood as including plants which have been modified by breeding, mutagenesis or genetic engineering including but not limiting to agricultural biotech products on the market or in development (cf. http://www.bio.org/speeches/pubs/er/agri_products.asp). Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transtional modification of protein(s), oligo- or polypeptides e. g. by glycosylation or polymer additions such as prenylated, acetylated or farnesylated moieties or PEG moieties.

In particular, the mixtures and compositions of the present invention are effective against plant pathogens in speciality crops such as vine, fruits, hop, vegetables and tabacco—see the above list.

Plant propagation materials may be treated with the mixtures and compositions of the invention prophylactically either at or before planting or transplanting.

The present invention also relates to a pesticidal agent comprising at least one solid or liquid carrier and a composition as described herein.

The compound I and compounds II, their N-oxides and salts can be converted into customary types of agrochemical compositions, e. g. solutions, emulsions, suspensions, dusts, powders, pastes and granules. The composition type depends on the particular intended purpose; in each case, it should ensure a fine and uniform distribution of the compound according to the invention.

Examples for composition types are suspensions (SC, OD, FS), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the composition types (e. g. SC, OD, FS, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively.

Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e. g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e. g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e. g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e. g., ammonium sulfate, ammonium phosphate, ammonium nitrate, ureas, and products of vegetable origin, such as cereal meal, tree bark meal, wood meal and nutshell meal, cellulose powders and other solid carriers.

The agrochemical compositions generally comprise between 0.01 and 95%, preferably between 0.1 and 90%, most preferably between 0.5 and 90%, by weight of active substance. The active substances are employed in a purity of from 90% to 100%, preferably from 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before sowing. Methods for applying or treating agrochemical compounds and compositions thereof, respectively, on to plant propagation material, especially seeds, are known in the art, and include dressing, coating, pelleting, dusting and soaking application methods of the propagation material. In a preferred embodiment, the compounds or the compositions thereof, respectively, are applied on to the plant propagation material by a method such that germination is not induced, e. g. by seed dressing, pelleting, coating and dusting.

The active substances can be used as such or in the form of their compositions, e. g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

When employed in plant protection, the amounts applied are, depending on the kind of effect desired, between 0.01 and 2.0 kg of active substance per ha.

In treatment of plant propagation materials such as seeds, e. g. by dusting, coating or drenching seed, amounts of active substance of from 1 to 1000 g, preferably from 5 to 100 g, per 100 kilogram of seed are generally required.

Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1.

The compositions according to the invention can, in the use form as fungicides, also be present together with other active substances, e. g. with herbicides, insecticides, growth regulators, fungicides or else with fertilizers, as pre-mix or, if appropriate, not until immediately prior to use (tank mix).

In the binary mixtures and compositions according to the invention the weight ratio of compound I and compound II generally depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1.

Any further active components are, if desired, added in a ratio of from 20:1 to 1:20 to the compound I.

In the ternary mixtures, i.e. compositions according to the invention comprising one compound I (component 1) and a compound II (component 2) and a compound III (component 3), e. g. two active substances from groups A) to I), the weight ratio of component 1) and component 2) depends from the properties of the active substances used, usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1, and the weight ratio of component 1) and component 3) usually it is in the range of from 1:100 to 100:1, regularly in the range of from 1:50 to 50:1, preferably in the range of from 1:20 to 20:1, more preferably in the range of from 1:10 to 10:1 and in particular in the range of from 1:4 to 4:1.

In the mixtures and compositions, the compound I/compound II/compound III ratio is advantageously chosen so as to produce a synergistic effect.

The term “synergstic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Netherl. J. Plant Pathol. 70, 1964).

The fungicidal action of the compositions according to the invention can be shown by the tests described below.

The active compounds, separately or jointly, are prepared as a stock solution comprising 25 mg of active compound which is made up to 10 ml using a mixture of acetone and/or DMSO and the emulsifier Uniperol® EL (wetting agent having an emulsifying and dispersing action based on ethoxylated alkylphenols) in a ratio by volume of solvent/emulsifier of 99:1. The mixture is then made up to 100 ml with water. This stock solution is diluted with the solvent/emulsifier/water mixture described to give the concentration of active compound stated below.

The visually determined percentages of infected leaf areas are converted into efficacies in % of the untreated control.

The efficacy (E) is calculated as follows using Abbot's formula:

E=(1−α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of active compound combinations were determined using Colby's formula (Colby, S. R. “Calculating synergistic and antagonistic responses of herbicide combinations”, Weeds, 15, pp. 20-22, 1967) and compared with the observed efficacies.

Colby's formula: E=x+y−x·y/100
E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b.

### Microtests

The active compounds were formulated separately as a stock solution having a concentration of 10000 ppm in dimethyl sulfoxide.

The stock solutions were mixed according to the ratio, pipetted onto a micro titer plate (MTP) and diluted with water to the stated concentrations. A spore suspension of the respective pathogen in the respective nutrient medium was then added. The plates were placed in a water vapor-saturated chamber at a temperature of 18° C. Using an absorption photometer, the MTPs were measured at 405 nm 7 days after the inoculation.

The measured parameters were compared to the growth of the active compound-free control variant (100%) and the fungus-free and active compound-free blank value to determine the relative growth in % of the pathogens in the respective active compounds. These percentages were converted into efficacies.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

### USE EXAMPLE 1

### Activity Against the Rice Blast Pathogen Pyricularia Oryzae

A spore suspension of Pyricularia oryzae containing an aqueous biomalt solution was used.

| | | | | Calculated |
|---|---|---|---|---|
| | | | | efficacy |
| Active compound/ | Concentration | | Observed | acc. to |
| active mixture | (ppm) | Mixture | efficacy | Colby (%) |
| I-17 | 4 | — | 56 | |
| I-18 | 4 | — | 57 | |
| I-5 | 4 | — | 58 | |

| | | | | Calculated |
|---|---|---|---|---|
| | | | | efficacy |
| Active compound/ | Concentration | | Observed | acc. to |
| active mixture | (ppm) | Mixture | efficacy | Colby (%) |
| II-1 | 63 | — | 27 | |
| I-17 + II-1 | 4 + 64 | 1:16 | 90 | 68 |
| I-18 + II-1 | 4 + 63 | 1:16 | 91 | 69 |
| I-5 + II-1 | 4 + 63 | 1:16 | 92 | 70 |

### USE EXAMPLE 2

### Activity Against the Grey Mold Pathogen Botrytis Cinerea

A spore suspension of Botrytis cinerea containing an aqueous biomalt solution was used.

| | | | | Calculated |
|---|---|---|---|---|
| | | | | efficacy |
| Active compound/ | Concentration | | Observed | acc. to |
| active mixture | (ppm) | Mixture | efficacy | Colby (%) |
| I-17 | 4 | — | 5 | |
| I-18 | 4 | — | 4 | |
| I-19 | 1 | — | 12 | |
| I-5 | 1 | — | 14 | |
| II-1 | 63 | — | 24 | |
| II-1 | 16 | — | 8 | |
| Fluxapyroxad | 0.063 | — | 29 | |
| I-17 + II-1 | 4 + 63 | 1:16 | 47 | 27 |
| I-18 + II-1 | 4 + 63 | 1:16 | 50 | 27 |
| I-19 + II-1 | 1 + 16 | 1:16 | 42 | 20 |
| I-5 + | 1 + 0.063 | 16:1 | 56 | 39 |
| Fluxapyroxad | | | | |

1-11. (canceled)

12. A mixture, comprising as active compounds
1) at least one compound of formula I 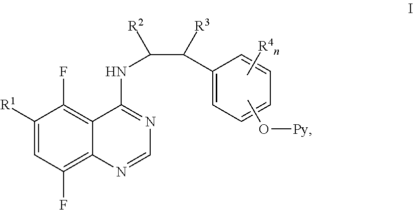
wherein:
R¹ is H or F;
R² is H or CH₃;
R³ is H or CH₃;
R⁴ is CN, halogen, C₁-C₂-alkyl or C₁-C₂-alkoxy;
n indicates the number of substituents R⁴ on the phenyl ring and n is 0, 1 or 2;
Py is pyrimidyl or pyridyl, wherein the aforementioned heteroaromatic radicals are unsubstituted or carry 1, 2 or 3 identical or different substituents R^{a}; R^{a} is CN, halogen, C₁-C₂-alkyl, C₁-C₂-haloalkyl or C₁-C₂-alkoxy;
or an N-oxide or an agriculturally acceptable salt of the compound of the formula I;
and
2) at least one fungicidally active compound II selected from the group consisting of fluxapyroxad, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-[3-(2-chlorophenyl)-2-(3-fluorophenyl)-oxiranylmethyl]-2H-[1,2,4]triazole-3-thiol, 2-[2-(3-fluorophenyl)-3-(2-fluorophenyl)-oxiranylmethyl]-2H-[1,2,4]triazole-3-thiol, 2-[(3-fluorophenyl)-3-o-tolyl-oxiranylmethyl]-2H-[1,2,4]triazole-3-thiol, 1-[2-(3-fluorophenyl)-3-(2-fluorophenyl)-oxiranylmethyl]-5 -methylsulfanyl-1H-[1,2,4]triazole, 1-[2-(3-fluorophenyl)-3 -o-tolyloxiranylmethyl]-5-methylsulfanyl-1H-[1,2,4]triazole, 1-[3-(2-chlorophenyl)-2-(3-fluorophenyl)-oxiranylmethyl]-5-methylsulfanyl-1H-[1,2,4]triazole, 1-[3-(2-chlorophenyl)-2-(3-fluorophenyl)-oxiranylmethyl]-5-methanesulfonyl-1H-[1,2,4]triazole, thiocarbonic acid S-{2-[3-(2-chlorophenyl)-2-(3-fluorophenyl)-oxiranylmethyl]-2H-[1,2,4]triazol-3-yl}ester methyl ester, 1-[3-(2-chlorophenyl)-2-(3-fluorophenyl)-oxiranylmethyl]-5-thiocyanato-1H-[1,2,4]triazole, thioacetic acid S-{2-[3-(2-chlorophenyl)-2-(3-fluorophenyl)-oxiranylmethyl]-2H-[1,2,4]triazol-3-yl}ester, 2-[3-(2-chlorophenyl)-2-(2,4-difluorophenyl)-oxiranylmethyl]-2H-[1,2,4]triazole-3-thiol, 2-[2-(3,4-difluorophenyl)-3-o-tolyl-oxiranylmethyl]-2H-[1,2,4]triazole-3-thiol, 2-[3-(2-chlorophenyl)-2-(3,4-difluorophenyl)-oxiranylmethyl]-2H-[1,2,4]triazole-3-thiol, 2-[2-(3,4-difluorophenyl)-3-(2-trifluoromethylphenyl)-oxiranylmethyl]-2H-[1,2,4]triazole-3-thiol, 1-[3-(2-chlorophenyl)-2-(3,4-difluorophenyl)-oxiranylmethyl]-5-methylsulfanyl-1H-[1,2,4]triazole, 1-[2-(2,4-difluorophenyl)-3-(2-fluorophenyl)-oxiranylmethyl]-5-methylsulfanyl-1H-[1,2,4]triazole, 1-[3-(2-chlorophenyl)-2-(2,4-difluorophenyl)-oxiranylmethyl]-5-methylsulfanyl-1H-[1,2,4]triazole, 1-[3-(2-chlorophenyl)-2-(2,4-difluorophenyl)-oxiranylmethyl]-5-thiocyanato-1H-[1,2,4]triazole, thiocarbonic acid S-{2-[3-(2-chlorophenyl)-2-(2,4-difluorophenyl)-oxiranylmethyl]-2H-[1,2,4]triazol-3-yl}ester methyl ester, 2-[2-(2-chlorophenyl)-3-(2,4-dichlorophenyl)-oxiranylmethyl]-2H-[1,2,4]triazole-3-thiol, 2-[3-(3-chloro-2-fluorophenyl)-2-(4-fluorophenyl)-oxiranylmethyl]-2H-[1,2,4]triazole-3-thiol, 2-[2-phenyl-3-(2,3,4-trichlorophenyl)-oxiranylmethyl]-2H-[1,2,4]triazole-3-thiol, 1-[2-(2-chlorophenyl)-3-(2,4-dichlorophenyl)-oxiranylmethyl]-5-methylsulfanyl-1H-[1,2,4]triazole, 1-[3-(3-chloro-2-fluorophenyl)-2-(4-fluorophenyl)-oxiranylmethyl]-5-methylsulfanyl-1H-[1,2,4]triazole, 1-[2-phenyl-3-(2,3,4-trichlorophenyl)-oxiranylmethyl]-5-methylsulfanyl-1H-[1,2,4]triazole, 1-[2-(2-chlorophenyl)-3-(2,4-dichlorophenyl)-oxiranylmethyl]-5-methanesulfonyl-1H-[1,2,4]triazole, thiocarbonic acid S-{2-[2-(2-chlorophenyl)-3-(2,4-dichlorophenyl)-oxiranylmethyl1-2H-[1,2,4]triazol-3-yl}ester methyl ester, 1-[2-(2-chlorophenyl)-3-(2,4-dichlorophenyl)-oxiranylmethyl]-5-thiocyanato-1H-[1,2,4]triazole, 2-[3-(2-chlorophenyl)-2-(2-fluorophenyl)-oxiranylmethyl]-2H-[1,2,4]triazole-3-thiol, 1-[3-(2-chlorophenyl)-2-(2-fluorophenyl)-oxiranylmethyl]-5-methylsulfanyl-1H-[1,2,4]triazole, 1-[3-(2-chlorophenyl)-2-(2-fluorophenyl)-oxiranylmethyl]-5-thiocyanato-1H-[1,2,4]triazolo, thiocarbonic acid S-{2-[3-(2-chlorophenyl)-2-(2-fluorophenyl)-oxiranylmethyl]-2H-[1,2,4]triazol-3-yl}ester methyl ester, 2-[3-(2-chlorophenyl)-2-(4-fluorophenyl)-oxiranylmethyl]-2H-[1,2,4]triazole-3-thiol, 5-allylsulfanyl-1-[3-(2-chlorophenyl)-2-(2,4-difluorophenyl)oxiran-2-yl]methyl]-1,2,4-triazole, 2-[1-[3-(2,4-dichlorophenyl)-2-methylpropyl]-2-hydroxy-3,3-dimethylbutyl]-4H-1,2,4-triazole-3-thione, 3-chloro-5-(6-chloro-3-pyridyl)-6-methyl-4-(2,4,6-trifluorophenyl)pyridazine, N-[2-(2,4-dichlorophenyl)-2-methoxy-1-methyl-ethyl]-3-(difluoromethyl)-1-methylpyrazole-4-carboxamide, a compound of formula IIa 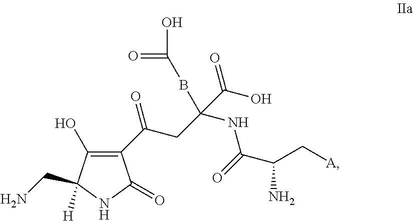
wherein:
B is a direct bond or an alkylene group;
A is OH or H;
and an antifungal biocontrol agent or an plant bioactivator selected from the group consisting of Ampelomyces quisqualis, Aspergillus flavus, Aureobasidium pullulans, Bacillus pumilus, Bacillus subtilis, Bacillus subtilis var. amyloliquefaciens FZB24, Candida saitoana, Chitosan, Coniothyrium minitans, Cryphonectria parasitica, Cryptococcus albidus, Metschnikowia fructicola, Microdochiurn dimerum, Pseudozyma flocculosa, Pythium oligandrum DV74, Reynoutria sachlinensis, Talaromyces flavus V117b, Trichoderma asperellum SKT-1, T. atroviride LC52, T. harzianum T-22, T. harzianum TH 35, T. harzianum T-39, T. harzianum and T. viride, T. harzianum ICC012 and T. viride ICC080, T. polysporum and T. harzianum, T. stromaticum, T. vixens GL-21, T. viride, T. viride TV1, and Ulocladium oudemansii HRU3;
in a synergistically effective amount.

13. The mixture of claim 12, wherein the compound I and the compound II are present in a weight ratio of from 100:1 to 1:100.

14. The mixture of claim 12, wherein the at least one compound I is selected from the group consisting of
(5,8-difluoro-quinazolin-4-yl)-{2-[4-(2-trifluoromethyl-pyridin-3-yloxy)-phenyl]-ethyl}-amine (I-1),
(5,8-difluoro-quinazolin-4-yl)-{2-[4-(4-trifluoromethyl-pyridin-3-yloxy)-phenyl]-propyl}-amine (I-2),
(5,8-difluoro-quinazolin-4-yl)-{2-[4 -(6-trifluoromethyl-pyrimidin-4-yloxy)-phenyl]-ethyl}-amine (I-3),
(5,8-difluoro-quinazolin-4-yl)-{2-[4-(6-trifluoromethyl-pyrimidin-4-yloxy)-phenyl]-propyl}-amine (I-4),
(5,8-difluoro-quinazolin-4-yl)-{2-[4-(4-trifluoromethyl-pyridin-2-yloxy)-phenyl]-ethyl}-amine (I-5),
(5,8-Difluoro-quinazolin-4-yl)-{2-[4-(4-trifluoromethyl-pyridin-2-yloxy)-phenyl]-propyl}-amine (I-6),
(5,8-difluoro-quinazolin-4-yl)-{2-[4-(5-trifluoromethyl-pyridin-2-yloxy)-phenyl]-ethyl}-amine (I-7),
(5,8-difluoro-quinazolin-4-yl)-{2-[4-(5-trifluoromethyl-pyridin-2-yloxy)-phenyl]-propyl}-amine (I-8),
(5,8-difluoro-quinazolin-4-yl)-{2-[4-(3-fluoro-5-trifluoromethyl-pyridin-2-yloxy)-phenyl]-ethyl}-amine (I-9),
(5,8-difluoro-quinazolin-4-yl)-{2-[4-(3-fluoro-5-trifluoromethyl-pyridin-2-yloxy)-phenyl[-propyl}-amine (I-10),
(5,8-difluoro-quinazolin-4-yl)-{2-[3 -methoxy-4-(4-trifluoromethyl-pyridin-2-yloxy)-phenyl]-ethyl}-amine (I-11),
(5,8-difluoro-quinazolin-4-yl)-{2-[2-fluoro-4-(4-trifluoromethyl-pyridin-2-yloxy)-phenyl]-ethyl}-amine (I-12),
2-chloro-5-{4-[2-(5,8-difluoro-quinazolin-4-ylamino)-ethyl]-phenoxy]-isonicotinonitrile (I-13),
(5,6,8-trifluoro-quinazolin-4-yl)-{2-[4-(4-trifluoromethyl-pyridin-2-yloxy)-phenyl]-ethyl}-amine (I-14),
(5,6,8-trifluoro-quinazolin-4-yl)-{2-[4-(4-trifluoromethyl-pyridin-3-yloxy)-phenyl]-ethyl}-amine (I-15),
(5,6,8-trifluoro-quinazolin-4-yl)-{2-[3-chloro-4-(4-trifluoromethyl-pyridin-3-yloxy)-phenyl]-ethyl}-amine (I-16),
(5,8-difluoro-quinazolin-4-yl)-{2-[4-(3-chloro-5-trifluoromethyl-pyridin-2-yloxy)-3-methoxy-phenyl]-ethyl}-amine (I-17),
(5,8-difluoro-quinazolin-4-yl)-{2-[4-(4-trifluoromethyl-pyridin-2-yloxy)-3-methoxy-phenyl]-ethyl}-amine (I-18), and
(5,6,8-trifluoro-quinazolin-4-yl)-{2-[4-(4-trifluoromethyl-pyridin-2-yloxy)-3-methoxy-phenyl]-ethyl}-amine (I-19).

15. The mixture of claim 12, wherein the at least one compound II comprises an antifungal biocontrol agent or a plant bioactivator selected from the group consisting of Bacillus pumilus, Bacillus subtilis, Bacillus subtilis var. amyloliquefaciens FZB24, and Ulocladium oudemansii HRU3.

16. The mixture of claim 12, wherein the at least one compound II is fluxapyroxad.

17. The mixture of claim 12, wherein the at least one compound II comprises a compound selected from the group consisting of:

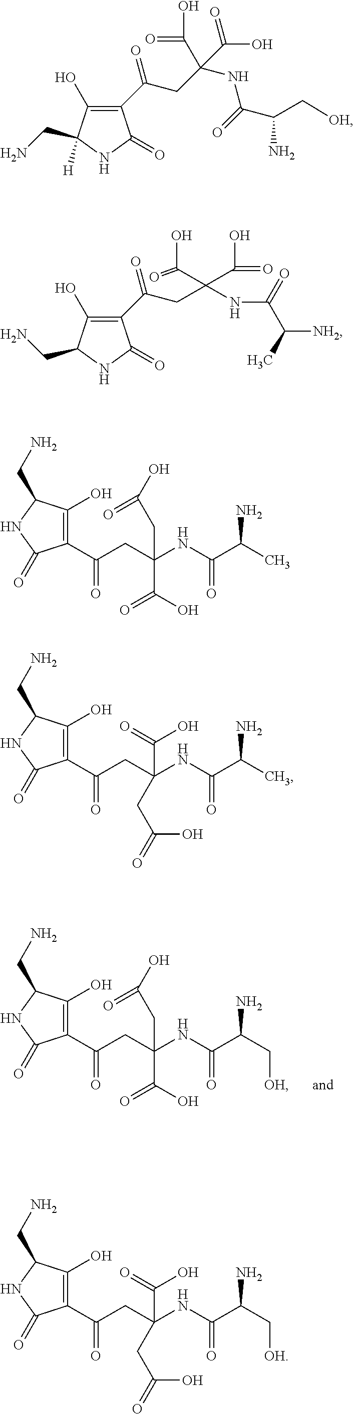

18. The mixture of claim 15, comprising a compound I and a compound II in a weight ratio of from 100:1 to 1:100.

19. The mixture of claim 12, further comprising at least one fungicidally active a compound III.

20. The mixture of claim 19, wherein the compound I and the compound II are present in a weight ratio of from 100:1 to 1:100, and the compound I and the compound III are present in a weight ratio of from 100:1 to 1:100.

21. An agrochemical composition comprising a solvent or solid carrier and the mixture of claim 12.

22. A method for controlling phytopathogenic harmful fungi comprising treating the fungi, their habitat or the seed, the soil or the plants to be protected against fungal attack with an effective amount of
1) at least one compound of formula I 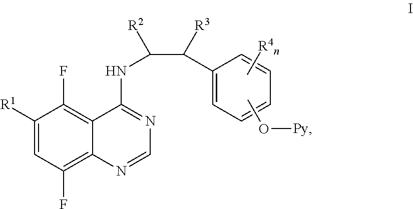
wherein:
R¹ is H or F;
R² is H or CH₃;
R³ is H or CH₃;
R⁴ is CN, halogen, C₁-C₂-alkyl or C₁-C₂-alkoxy;
n indicates the number of substituents R⁴ on the phenyl ring and n is 0, 1 or 2;
Py is pyrimidyl or pyridyl, wherein the aforementioned heteroaromatic radicals are unsubstituted or carry 1, 2 or 3 identical or different substituents R^{a}; R^{a} is CN, halogen, C₁-C₂-alkyl, C₁-C₂-haloalkyl or C₁-C₂-alkoxy;
or an N-oxide or an agriculturally acceptable salt of the compound of the formula I;
and
3) at least one fungicidally active compound II selected from the group consisting of fluxapyroxad, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)-phenyl)-N-ethyl-N-methyl formamidine, 2-[3-(2-chlorophenyl)-2-(3-fluorophenyl)-oxiranylmethyl]-2H-[1,2,4]triazole-3-thiol, 2-[2-(3-fluorophenyl)-3-(2-fluorophenyl)-oxiranylmethyl]-2H-[1,2,4]triazole-3-thiol, 2-[(3-fluorophenyl)-3-o-tolyl-oxiranylmethyl]-2H-[1,2,4]triazole-3-thiol, 1-[2-(3-fluorophenyl)-3-(2-fluorophenyl)-oxiranylmethyl]-5-methylsulfanyl-1H-[1,2,4]triazole, 1-[2-(3-fluorophenyl)-3 -o-tolyloxiranylmethyl]-5-methylsulfanyl-1H-[1,2,4]triazole, 1-[3-(2-chlorophenyl)-2-(3-fluorophenyl)-oxiranylmethyl]-5-methylsulfanyl-1H-[1,2,4]triazole, 1-[3-(2-chlorophenyl)-2-(3-fluorophenyl)-oxiranylmethyl]-5-methanesulfonyl-1H-[1,2,4]triazole, thiocarbonic acid S-{2-[3-(2-chlorophenyl)-2-(3-fluorophenyl)-oxiranylmethyl]-2H-[1,2,4]triazol-3-yl}ester methyl ester, 1-[3-(2-chlorophenyl)-2-(3-fluorophenyl)-oxiranylmethyl]-5-thiocyanato-1H-[1,2,4]triazole, thioacetic acid S-{2-[3-(2-chlorophenyl)-2-(3-fluorophenyl)-oxiranylmethyl]-2H-[1,2,4]triazol-3-yl}ester, 2-[3-(2-chlorophenyl)-2-(2,4-difluorophenyl)-oxiranylmethyl]-2H-[1,2,4]triazole-3-thiol, 2-[2-(3,4-difluorophenyl)-3-o-tolyl-oxiranylmethyl]-2H-[1,2,4]triazole-3-thiol, 2-[3-(2-chlorophenyl)-2-(3,4-difluorophenyl)-oxiranylmethyl]-2H-[1,2,4]triazole-3-thiol, 2-[2-(3,4-difluorophenyl)-3-(2-trifluoromethylphenyl)-oxiranylmethyl]-2H-[1,2,4]triazole-3-thiol, 1-[3-(2-chlorophenyl)-2-(3,4-difluorophenyl)-oxiranylmethyl]-5-methylsulfanyl-1H-[1,2,4]triazole, 1-[2-(2,4-difluorophenyl)-3-(2-fluorophenyl)-oxiranylmethyl]-5-methylsulfanyl-1H-[1,2,4]triazole, 1-[3-(2-chlorophenyl)-2-(2,4-difluorophenyl)-oxiranylmethyl]-5-methylsulfanyl-1H-[1,2,4]triazole, 1-[3-(2-chlorophenyl)-2-(2,4-difluorophenyl)-oxiranylmethyl]-5-thiocyanato-1H-[1,2,4]triazole, thiocarbonic acid S-{2-[3-(2-chlorophenyl)-2-(2,4-difluorophenyl)-oxiranylmethyl]-2H-[1,2,4]triazol-3-yl}ester methyl ester, 2-[2-(2-chlorophenyl)-3-(2,4-dichlorophenyl)-oxiranylmethyl]-2H-[1,2,4]triazole-3-thiol, 2-[3-(3-chloro-2-fluorophenyl)-2-(4-fluorophenyl)-oxiranylmethyl]-2H-[1,2,4]triazole-3-thiol, 2-[2-phenyl-3-(2,3,4-trichlorophenyl)-oxiranylmethyl]-2H-[1,2,4]triazole-3-thiol, 1-[2-(2-chlorophenyl)-3-(2,4-dichlorophenyl)-oxiranylmethyl]-5-methylsulfanyl-1H-[1,2,4]triazole, 1-[3-(3-chloro-2-fluorophenyl)-2-(4-fluorophenyl)-oxiranylmethyl]-5-methylsulfanyl-1H-[1,2,4]triazole, 1[2-phenyl-3-(2,3,4-trichlorophenyl)-oxiranylmethyl]-5-methylsulfanyl-1H-[1,2,4]triazole, 1-[2-(2-chlorophenyl)-3-(2,4-dichlorophenyl)-oxiranylmethyl]-5-methanesulfonyl-1H-[1,2,4]triazole, thiocarbonic acid S-{2-[2-(2-chlorophenyl)-3-(2,4-dichlorophenyl)-oxiranylmethyl]-2H-[1,2,4]triazol-3-yl}ester methyl ester, 1-[2-(2-chlorophenyl)-3-(2,4-dichlorophenyl)-oxiranylmethyl]-5-thiocyanato-1H-[1,2,4]triazole, 2-[3-(2-chlorophenyl)-2-(2-fluorophenyl)-oxiranylmethyl]-2H-[1,2,4]triazole-3-thiol, 1-[3-(2-chlorophenyl)-2-(2-fluorophenyl)-oxiranylmethyl]-5-methylsulfanyl-1H-[1,2,4]triazole, 1-[3-(2-chlorophenyl)-2-(2-fluorophenyl)-oxiranylmethyl]-5-thiocyanato-1H-[1,2,4]triazolo, thiocarbonic acid S-{2-[3-(2-chlorophenyl)-2-(2-fluorophenyl)-oxiranylmethyl]-2H-[1,2,4]triazol-3-yl}ester methyl ester, 2-[3-(2-chlorophenyl)-2-(4-fluorophenyl)-oxiranylmethyl]-2H-[1,2,4]triazole-3-thiol, 5-allylsulfanyl-1-[3-(2-chlorophenyl)-2-(2,4-difluorophenyl)oxiran-2-yl]methyl]-1,2,4-triazole, 2-[1-[3-(2,4-dichlorophenyl)-2-methylpropyl]-2-hydroxy-3,3-dimethylbutyl]-4H-1,2,4-triazole-3-thione, 3-chloro-5-(6-chloro-3-pyridyl)-6-methyl-4-(2,4,6-trifluorophenyl)pyridazine, N-[2-(2,4-dichlorophenyl)-2-methoxy-1-methyl-ethyl]-3-(difluoromethyl)-1-methyl-pyrazole-4-carboxamide, a compound of formula IIa 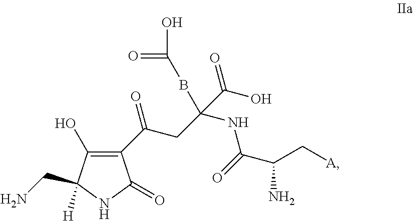
wherein:
B is a direct bond or an alkylene group;
A is OH or H;
and an antifungal biocontrol agent or a plant bioactivator selected from the group consisting of Ampelomyces quisqualis, Aspergillus flavus, Aureobasidium pullulans, Bacillus pumilus, Bacillus subtilis, Bacillus subtilis var. amyloliquefaciens FZB24, Candida saitoana, Chitosan, Coniothyrium minitans, Cryphonectria parasitica, Cryptococcus albidus, Metschnikowia fructicola, Microdochiurn dimerum, Pseudozyma flocculosa, Pythium oligandrum DV74, Reynoutria sachlinensis, Talaromyces flavus V117b, Trichoderma asperellum SKT-1, T. atroviride LC52, T. harzianum T-22, T. harzianum TH 35, T. harzianum T-39, T. harzianum and T. viride, T. harzianum ICC012 and T. viride ICC080, T. polysporum and T. harzianum, T. stromaticum, T. vixens GL-21, T. viride, T. viride TV1, and Ulocladium oudemansii HRU3.

23. The method of claim 22, wherein the compound I and the compound II are in a weight ratio of from 100:1 to 1:100.

24. The method of claim 22, wherein the at least one compound I is selected from the group consisting of
(5,8-difluoro-quinazolin-4-yl)-{2-[4-(2-trifluoromethyl-pyridin-3-yloxy)-phenyl]-ethyl}-amine (I-1),
(5,8-difluoro-quinazolin-4-yl)-{2-[4-(4-trifluoromethyl-pyridin-3-yloxy)-phenyl]-propyl}-amine (I-2),
(5,8-difluoro-quinazolin-4-yl)-{2-[4 -(6-trifluoromethyl-pyrimidin-4-yloxy)-phenyl]-ethyl}-amine (I-3),
(5,8-difluoro-quinazolin-4-yl)-{2-[4-(6-trifluoromethyl-pyrimidin-4-yloxy)-phenyl]-propyl}-amine (I-4),
(5,8-difluoro-quinazolin-4-yl)-{2-[4-(4-trifluoromethyl-pyridin-2-yloxy)-phenyl]-ethyl}-amine (I-5),
(5,8-Difluoro-quinazolin-4-yl)-{2-[4-(4-trifluoromethyl-pyridin-2-yloxy)-phenyl]-propyl}-amine (I-6),
(5,8-difluoro-quinazolin-4-yl)-{2-[4-(5-trifluoromethyl-pyridin-2-yloxy)-phenyl]-ethyl}-amine (I-7),
(5,8-difluoro-quinazolin-4-yl)-{2-[4-(5-trifluoromethyl-pyridin-2-yloxy)-phenyl]-propyl}-amine (I-8),
(5,8-difluoro-quinazolin-4-yl)-{2-[4-(3-fluoro-5-trifluoromethyl-pyridin-2-yloxy)-phenyl]-ethyl}-amine (I-9),
(5,8-difluoro-quinazolin-4-yl)-{2-[4-(3-fluoro-5-trifluoromethyl-pyridin-2-yloxy)-phenyl]-propyl}-amine (I-10),
(5,8-difluoro-quinazolin-4-yl)-{2-[3 -methoxy-4-(4-trifluoromethyl-pyridin-2-yloxy)-phenyl}-ethyl}-amine (I-11),
(5,8-difluoro-quinazolin-4-yl)-{2-[2-fluoro-4-(4-trifluoromethyl-pyridin-2-yloxy)-phenyl]-ethyl}-amine (I-12),
2-chloro-5-{4-[2-(5,8-difluoro-quinazolin-4-ylamino)-ethyl]-phenoxy}-isonicotinonitrile (I-13),
(5,6,8-trifluoro-quinazolin-4-yl)-{2-[4-(4-trifluoromethyl-pyridin-2-yloxy)-phenyl]-ethyl}-amine (I-14),
(5,6,8-trifluoro-quinazolin-4-yl)-{2-[4-(4-trifluoromethyl-pyridin-3-yloxy)-phenyl]-ethyl}-amine (I-15),
(5,6,8-trifluoro-quinazolin-4-yl)-{2-[3-chloro-4-(4-trifluoromethyl-pyridin-3-yloxy)-phenyl]-ethyl}-amine (I-16),
(5,8-difluoro-quinazolin-4-yl)-{2-[4-(3-chloro-5-trifluoromethyl-pyridin-2-yloxy)-3-methoxy-phenyl]-ethyl}-amine (I-17),
(5,8-difluoro-quinazolin-4-yl)-{2-[4-(4-trifluoromethyl-pyridin-2-yloxy)-3-methoxy-phenyl]-ethyl}-amine (I-18), and
(5,6,8-trifluoro-quinazolin-4-yl)-{2-[4-(4-trifluoromethyl-pyridin-2-yloxy)-3-methoxy-phenyl]-ethyl}-amine (I-19).

25. The method of claim 22, wherein the at least one compound II comprises an antifungal biocontrol agent and plant bioactivator selected from the group consisting of Bacillus pumilus, Bacillus subtilis, Bacillus subtilis var. amyloliquefaciens FZB24, and Ulocladium oudemansii HRU3.

26. A method for controlling phytopathogenic harmful fungi comprising treating the fungi, their habitat or the seed, the soil or the plants to be protected against fungal attack with an effective amount of the composition of claim 21.

27. The method of claim 26, wherein the compound I and the compound II are in a weight ratio of from 100:1 to 1:100.

28. The method of claim 26, wherein the at least one compound I is selected from the group consisting of
(5,8-difluoro-quinazolin-4-yl)-{2-[4-(2-trifluoromethyl-pyridin-3-yloxy)-phenyl]-ethyl}-amine (I-1),
(5,8-difluoro-quinazolin-4-yl)-{2-[4-(4-trifluoromethyl-pyridin-3-yloxy)-phenyl]-propyl}-amine (I-2),
(5,8-difluoro-quinazolin-4-yl)-{2-[4 -(6-trifluoromethyl-pyrimidin-4-yloxy)-phenyl]-ethyl}-amine (I-3),
(5,8-difluoro-quinazolin-4-yl)-{2-[4-(6-trifluoromethyl-pyrimidin-4-yloxy)-phenyl]-propyl}-amine (I-4),
(5,8-difluoro-quinazolin-4-yl)-{2-[4-(4-trifluoromethyl-pyridin-2-yloxy)-phenyl]-ethyl}-amine (I-5),
(5,8-Difluoro-quinazolin-4-yl)-{2-[4-(4-trifluoromethyl-pyridin-2-yloxy)-phenyl]-propyl}-amine (I-6),
(5,8-difluoro-quinazolin-4-yl)-{2-[4-(5-trifluoromethyl-pyridin-2-yloxy)-phenyl]-ethyl}-amine (I-7),
(5,8-difluoro-quinazolin-4-yl)-{2-[4-(5-trifluoromethyl-pyridin-2-yloxy)-phenyl]-propyl}-amine (I-8),
(5,8-difluoro-quinazolin-4-yl)-{2-[4-(3-fluoro-5-trifluoromethyl-pyridin-2-yloxy)-phenyl]-ethyl}-amine (I-9),
(5,8-difluoro-quinazolin-4-yl)-{2-[4-(3-fluoro-5-trifluoromethyl-pyridin-2-yloxy)-phenyl]-propyl}-amine (I-10),
(5,8-difluoro-quinazolin-4-yl)-{2-[3-methoxy-4-(4-trifluoromethyl-pyridin-2-yloxy)-phenyl]-ethyl}-amine (I-11),
(5,8-difluoro-quinazolin-4-yl)-{2-[2-fluoro-4-(4-trifluoromethyl-pyridin-2-yloxy)-phenyl]-ethyl}-amine (I-12),
2-chloro-5-{4-[2-(5,8-difluoro-quinazolin-4-ylamino)-ethyl]-phenoxy}-isonicotinonitrile (I-13),
(5,6,8-trifluoro-quinazolin-4-yl)-{2-[4-(4-trifluoromethyl-pyridin-2-yloxy)-phenyl]-ethyl}-amine (I-14),
(5,6,8-trifluoro-quinazolin-4-yl)-{2-[4-(4-trifluoromethyl-pyridin-3-yloxy)-phenyl]-ethyl}-amine (I-15),
(5,6,8-trifluoro-quinazolin-4-yl)-{2-[3-chloro-4-(4-trifluoromethyl-pyridin-3-yloxy)-phenyl]-ethyl}-amine (I-16),
(5,8-difluoro-quinazolin-4-yl)-{2-[4-(3-chloro-5-trifluoromethyl-pyridin-2-yloxy)-3-methoxy-phenyl]-ethyl}-amine (I-17),
(5,8-difluoro-quinazolin-4-yl)-{2-[4-(4-trifluoromethyl-pyridin-2-yloxy)-3-methoxy-phenyl]-ethyl}-amine (I-18), and
(5,6, 8-trifluoro-quinazolin-4-yl)-{2-[4-(4-trifluoromethyl-pyridin-2-yloxy)-3-methoxy-phenyl]- ethyl}-amine (I-19).

29. The method of claim 26, wherein the at least one compound II comprises an antifungal biocontrol agent and plant bioactivator selected from the group consisting of Bacillus pumilus, Bacillus subtilis, Bacillus subtilis var. amyloliquefaciens, and Ulocladium oudemansii HRU3.

30. A seed comprising the mixture of claim 12 in an amount of from 1 g to 1000 g active compounds per 100 kg of seed.

31. A seed comprising the composition of claim 21 in an amount of from 1 g to 1000 g active compounds per 100 kg of seed.
